(19) United States
(12) Patent Application Publication
(10) Pub. No.: US 2022/0072443 A1
(43) Pub. Date: Mar. 10, 2022

(54) SYSTEM AND METHOD FOR PROVIDING A PHOSPHORESCENT LIQUID WRITING SURFACE

(71) Applicant: Kyle Sliger, Tempe, AZ (US)

(72) Inventor: Kyle Sliger, Tempe, AZ (US)

(21) Appl. No.: 17/166,332

(22) Filed: Feb. 3, 2021

Related U.S. Application Data
(60) Provisional application No. 63/074,632, filed on Sep. 4, 2020.

(51) Int. Cl. A63H 33/22; B43L 1/00; B05D 7/00

(52) U.S. Cl. CPC A63H 33/22; B05D 7/546; B43L 1/002

(57) ABSTRACT

A phosphorescence and liquid toy comprising a pad having a first substrate and a second substrate wherein a first coating is applied to the first substrate. A second coating applied to the first coating and the first substrate wherein the second substrate is attached to the back side of the first substrate. The first coating having a liquid reactive material and the second coating having a phosphorescent reactive material. A pen having a cylindrical tube terminating in a tip on one end and opening on the other end creating a refillable reservoir wherein the reservoir is filled with liquid and a cap is removably attached to the opening.

### CROSS REFERENCE TO RELATED APPLICATIONS

The present application claims the benefit under 35 U.S.C. 119 of U.S. Provisional Patent Application Ser. No. 63/074,632 filed Sep. 4, 2020. The U.S. Provisional Patent Application Ser. No. 63/074,632 is hereby incorporated by reference in its entirety.

### FIELD OF THE INVENTION

The present invention relates to generally to a writing pad, more particularly to a toy writing pad that can be written on with water and glow in the dark ink that disappears after the ink dries.

### BACKGROUND OF THE INVENTION

People of all ages, and especially children, like to draw pictures, doodle, write messages or the like. For smaller children, this experience provides a learning activity that can help them develop motor skills and exercise creativity. From the parent's viewpoint the drawing, doodling, and writing is a fun activity that helps create an added interest which can induce the child to undertake and retain activities associated with learning. Glow in the dark ink allows for the child to continue the fun in a darker atmosphere, and glow-in-the-dark materials are fun in and of themselves. Current glow in the dark writing technology employs the use of luminescent, fluorescent, or phosphorescent matter or ink which after being illuminated glows brightly in the dark. This type of technology is limited in that it permanently stays on the surface that it is put on and/or fades away after a period of time. In addition, the user can only use the writing surface and pen in a dark room limiting its use.

Another type of writing device uses water with thin sheets of material or paper that become see-through showing vivid and bright colors when wet and then quickly drying allowing the child to reuse the device over and over again. The user can use a pen that is filled with water to wet the reactive material allowing the user to draw, doodle or write on the reactive material. The combination of a reactive material and a water pen allow the user to conveniently draw, write and doodle without making a mess. This type of writing device is limited in that it only allows the user to use the device with lighted conditions thus only allowing the user to use the writing device during daylight hours or when the light is on.

Accordingly, an object of the invention is to provide a new and improved means for and methods for providing entertainment with pen and writing surface that allows the user to use the device during the day and at night. Here, an objective is to provide a toy for use by children, especially small children.

Another object is to provide new activity accessories that can be used to dampen water and luminescent reactive material in order to provide fun and amusement for those who want to doodle or draw.

Another object is to provide a graphic pad which can be reused to practice drawing and writing and is able to survive repeated use both during lighted and dark conditions.

Although the application, or use, of luminescent, fluorescent or phosphorescent, bodies, or matter, may be said to be known, this invention discloses steps and products which extend beyond such known practices or inventions.

Therefore, there is a need for a device that allows the user to draw, doodle, and write in both lighted and darkened conditions.

### BRIEF SUMMARY OF THE INVENTION

In embodiments a phosphorescent writing pad comprises at least one substrate with at least two coatings applied to the substrate. One coating is a phosphorescent coating that can be charged with light energy and which glows in the dark. Another coating reacts in the presence of water to be clear or opaque. A pen is providing having a cylindrical tube with a tip on one end and an opening on the other end. Between the ends is a refillable reservoir that may be filled with water or anther liquid. A cap covers the opening to close the reservoir and another cap can be provided to cover the tip of the pen. A light source such as a black light, ultraviolet light or flashlight may be provided as a part of either cap. The cap incorporating the light source can be removably attached to the pen or a separate light implement may be removably attached to the pen by a connector.

The phosphorescence coating may be applied directly to the substrate, or may be applied to the substrate with another coating between the phosphorescence coating and the substrate. The other coating may be a liquid reactive material that includes silica and resin. The liquid can be any suitable liquid, such as water, tonic or luminous ink.

A method is also provided for manufacturing a phosphorescence liquid writing surface. A first substrate is attached to a second substrate with an attachment piece. The first substrate may be woven material polyester. A first coating is then applied to the first substrate and allowed to cure. A second coating is also applied and allowed to cure. A pen is provided comprising a cylindrical tube with a tip on a tip end and an opening on an opening end defining a refillable reservoir. The reservoir may be filled with a liquid such as water, tonic or luminous ink. A cap and a light source are removably attached to the pen.

Aspects and applications of the invention presented here are described below in the drawings and detailed description of the invention. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the. Absent such clear statements of intent to apply a “special” definition, it is the inventor's intent and desire that the simple, plain, and ordinary meaning to the terms be applied to the interpretation of the specification and claims.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. § 112 (f). Thus, the use of the words “function,” “means” or “step” in the Detailed Description or Description of the Drawings or claims is not intended to somehow indicate a desire to invoke the special provisions of 35 U.S.C. § 112 (f), to define the invention. To the contrary, if the provisions of 35 U.S.C. § 112 (f) are sought to be invoked to define the inventions, the claims will specifically and expressly state the exact phrases “means for” or “step for”, and will also recite the word “function” (i.e., will state “means for performing the function of molding a fishing lure, without also reciting in such phrases any structure, material or act in support of the function. Thus, even when the claims recite a “means for performing the function of molding a fishing lure, step for performing the function of molding a fishing lure,” if the claims also recite any structure, material or acts in support of that means or step, or that perform the recited function, then it is the clear intention of the inventors not to invoke the provisions of 35 U.S.C. § 112 (f). Moreover, even if the provisions of 35 U.S.C. § 112 (f) are invoked to define the claimed inventions, it is intended that the inventions not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

Additional features and advantages of the present specification will become apparent to those skilled in the art upon consideration of the following detailed description of the illustrative embodiment exemplifying the best mode of carrying out the invention as presently perceived.

### BRIEF DESCRIPTION OF THE DRAWINGS

These and other features, aspects, and advantages of the present specification will become better understood with regard to the following description, appended claims, and accompanying drawings where:

FIG. 1 is a side view of the luminescent and liquid writing toy in accordance to one, or more embodiments;

FIG. 2 is a exploded isometric view of the luminescent and liquid writing toy in accordance to one, or more embodiments;

FIG. 3 is a side view of an example embodiment of a luminescent and liquid writing toy in accordance to one, or more embodiments;

FIG. 4 is a side view of an example of a pen for a luminescent and liquid writing toy in accordance to one, or more embodiments; and

FIG. 5 is a manufacturing process for the luminescent and liquid writing toy in accordance to one, or more embodiments.

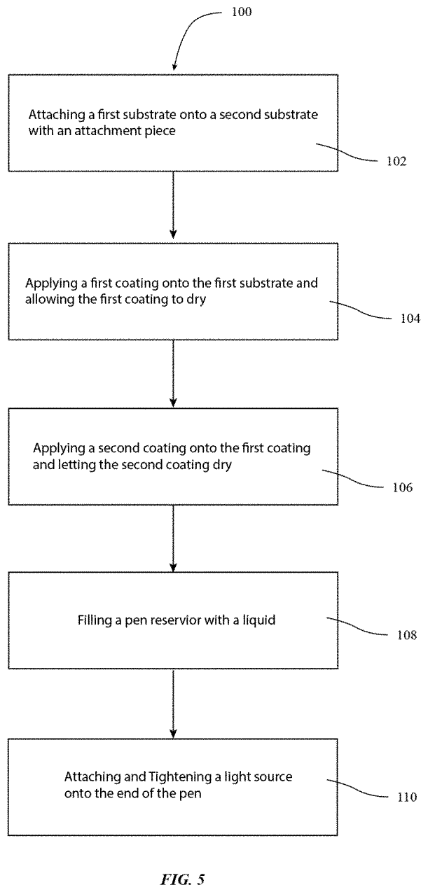

Elements and acts in the figures are illustrated for simplicity and have not necessarily been rendered according to any particular sequence or embodiment.

### DETAILED DESCRIPTION

In the following description, and for the purposes of explanation, numerous specific details are set forth in order to provide a thorough understanding of the various aspects of the invention. It will be understood, however, by those skilled in the relevant arts, that the present invention may be practiced without these specific details. In other instances, known structures and devices are shown or discussed more generally in order to avoid obscuring the invention. In many cases, a description of the operation is sufficient to enable one to implement the various forms of the invention, particularly when the operation is to be implemented in software. It should be noted that there are many different and alternative configurations, devices and technologies to which the disclosed inventions may be applied. The full scope of the inventions is not limited to the examples that are described below.

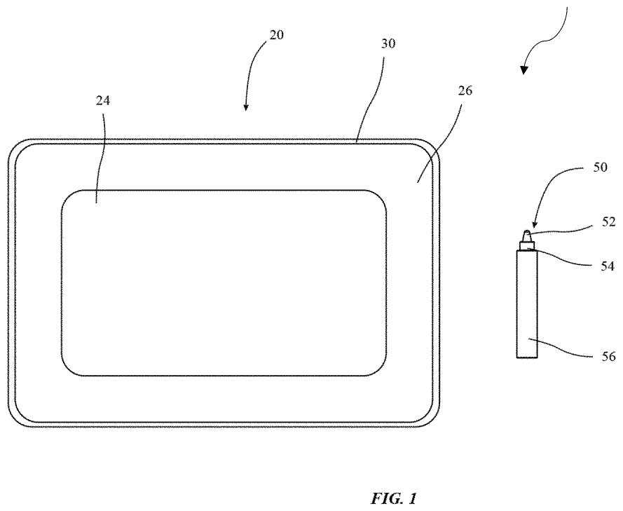

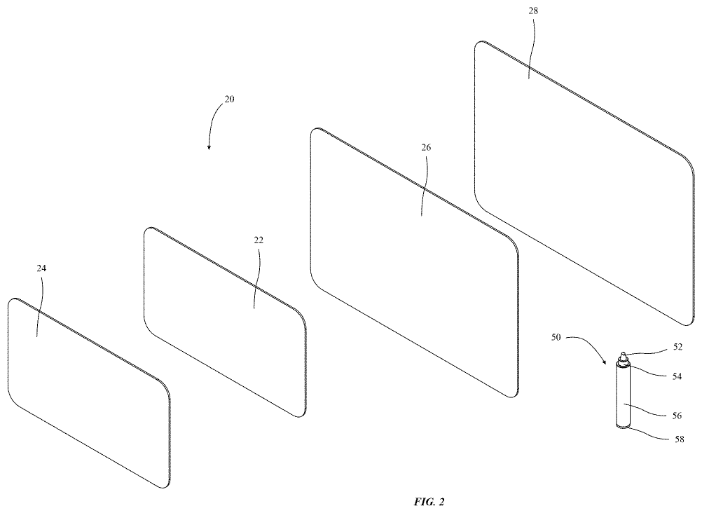

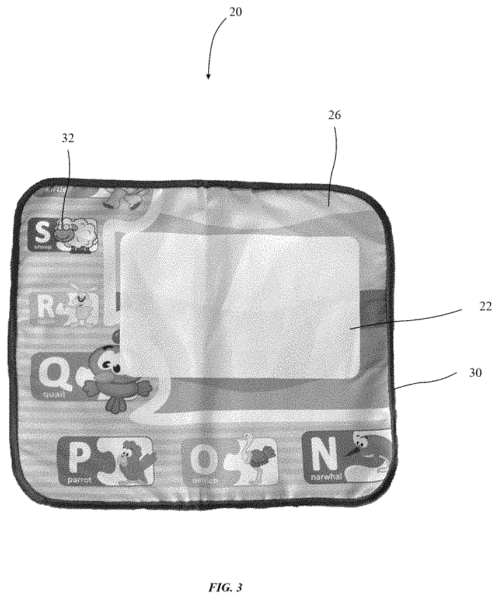

Referring initially to FIGS. 1-3 a front view of a luminescent and liquid writing or drawing system is shown generally at 10. The luminescent and liquid writing toy can comprise a pad 20 having a first substrate 26 with a first coating 22 overlaying the substrate and a second coating 24 overlaying the first coating. The first substrate 26 can have a second substrate 28 attached to its back side by any suitable attachment methods such as sewing, gluing, buttoning, fusible adhesive, or the like, or it can have a seem 30 around its outside border connecting the two together. The first substrate 26 and the second substrate 28 can be non-woven polyester, watertight peach polyester, transfer paper, vinyl, nylon, cotton, satin, denim, or the like. The first substrate 26 and second substrate 28 can vary in thickness wherein the thickness can be, for example, between 0.005 inches and 0.125 inches, more preferably a width of between 0.008 inches and 0.100 inches, and still more preferably a width of approximately 0.010 inches or the like.

The first coating 22 can be a liquid reactive material such as a sublimation ink, water changeable ink, water-abased polyurethane ink, or the like. The second coating 24 can be a phosphorescent material, phosphors zinc sulphide, strontium aluminate, luminous ink, luminous crystal, or the like. Phosphorescent material can be energized by shining a light on the phosphorescent material. Atoms inside phosphors are excited by the external light energy and they then emit light when the atoms return from their excited state to the ground state. When the phosphorescent material returns to its ground state, the glowing effect stops.

The second coating 24 can allow the liquid to penetrate to the first coating 22 allowing for a reaction between the liquid and the first coating 22 wherein the first coating 22 can change from opaque to transparent when the liquid is applied. As the first coating 22 dries, it reverts back to opaque. The first coating 22 and second coating 24 can be opaque when dry and transparent when wet. In other embodiments the second coating 24 can be applied to the first substrate and the first coating 22 can be applied to the second coating. The first coating 22 and the second coating 24 can be applied over the whole surface of the first substrate 26 or it can be applied on varying sections or sizes on the first substrate 26, or in different shapes on the first substrate 26. The portion of the first substrate 26 that is visible through the first coating 22 and the second coating 24 when the coatings 22, 44 are wet can be a solid color, a pattern, or different sections of the substrate 26 can be different colors.

When a liquid is applied to the second coating 24, the second coating can glow in the dark when the second coating 24 is energized with light energy. The second coating 24 can glow in the dark without a light being shined on the coating when a liquid is applied allowing the user to write and draw figures in the dark without the need of an external light source. The energizing light source can be, for example, ultraviolet light, black light, sun light, indoor lighting, or the like. The second coating 24 can be applied to the first coating 22 in layers wherein there can be one or more layers applied to the first coating. In certain embodiments, the second coating 24 can be omitted, or it can be integrated within the first coating 22 wherein the first coating can react when water is applied or when a light is applied to the surface.

The luminescent and liquid writing toy 20 can further comprise a pen 50 having a cylindrical tube 56 terminating in a tip on one end 52 and opening on the other end creating a refillable reservoir 56 wherein the reservoir is filled with liquid and a cap 58 that can be removably attached to the opening keeping the liquid from escaping the reservoir. The pen 50 can be circular, square, rectangular, or the like in shape and can have a reservoir that can be any suitable size to hold liquid. The liquid (not shown) can be for example, luminous ink, luminous crystal, tonic water, chlorophyll, glow powder, vitamin B12, or the like. The liquid (not shown) can be applied to the first coating 22 and can soak into the second coating 24 and the first substrate wherein when applied in lighted conditions the liquid can change the first coating, the second coating and the first substrate 26 transparent and when dry it becomes opaque. In the dark the first coating and/or second coating can glow when the liquid is applied.

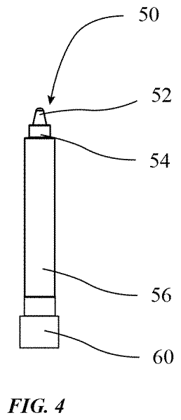

In embodiments when a UV light is applied to the second coating 24 it charges the particles within the ink so that particles are in an excited state resulting in a light being released from the second coating. The light emitted from the second coating can last from for example, 1 second, 1 minute, 10 minutes, 30 minutes, 1 hour, or the like. In other embodiments, the pen 50 can be combined with a light 60 wherein the light can be either removable attached to the cap 58 end or in place of the cap as shown in FIG. 4. The light 60 can vary in size and shape to fit the user's needs and the light can be, for example, ultraviolet light, black light, sunlight, indoor light or the like allowing for the particles to be excited when the light is pushed against the second coating. The light 60 can be screwed on, pushed on, snapped on, or the like, to the cap end of the pen 50. In other embodiments the light 60 and the pen 50 can be one or more pieces and can be manufactured from the same type of material such as plastic or metals. In certain embodiments the user may employ any suitable accessory or instrument to write on the first coating and the second coating.

In a particular embodiment a graphic image in a shape or pattern is revealed when the liquid is applied to the system by a user, the coatings 22, 24 become transparent and the unique pattern or shape drawn by the user. Other drawing and writing stencils may be used with the phosphorescence and liquid toy or different stencils can be embossed on the surface of the substrate 26 or one of the coatings 22, 24 allowing the user to trace the different shapes and characters.

A method of manufacturing a phosphorescence and liquid toy is also contemplated comprising attaching a first substrate 26 onto a second substrate 28 with an attachment piece 100. A first coating 22 is applied to the first substrate 26 and allowed to cure 102. A second coating 24 is applied to the first coating and is also allowed to cure 104. A pen 50 with a reservoir 56 is provided and the reservoir 56 is filled with a liquid that is in fluid contact with a tip 52 for writing. A cap 58 is provided for the pen 50 that may include a light 60 coupled to the cap 58. The light 60 may be screwed onto a threaded portion of the cap 58 or may be integrally contained in the cap or removably contained in the cap. The second substrate 28 can be omitted in certain embodiments. In other embodiments the second coating can be applied first and the first coating can be applied second. In other embodiments more than two coatings can be applied to the first substrate or second substrate and the first coating 22 is applied to another coating rather than directly to the first substrate. Other coatings can be layered onto the first coating and the second coating allowing for transparency when wet, glow in the dark when charged or glow in the dark liquid is applied, or different shapes and letters can appear if a liquid or light is applied. In certain embodiments the liquid can dry within a certain time or the liquid can sit on the coating and can be wiped off to make the coatings opaque.

In closing, it is to be understood that although aspects of the present specification are highlighted by referring to specific embodiments, one skilled in the art will readily appreciate that these disclosed embodiments are only illustrative of the principles of the subject matter disclosed herein. Therefore, it should be understood that the disclosed subject matter is in no way limited to a particular methodology, protocol, and/or reagent, etc., described herein. As such, various modifications or changes to or alternative configurations of the disclosed subject matter can be made in accordance with the teachings herein without departing from the spirit of the present specification. Lastly, the terminology used herein is for the purpose of describing particular embodiments only and is not intended to limit the scope of the present disclosure, which is defined solely by the claims. Accordingly, embodiments of the present disclosure are not limited to those precisely as shown and described.

Certain embodiments are described herein, including the best mode known to the inventors for carrying out the methods and devices described herein. Of course, variations on these described embodiments will become apparent to those of ordinary skill in the art upon reading the foregoing description. Accordingly, this disclosure includes all modifications and equivalents of the subject matter recited in the claims appended hereto as permitted by applicable law. Moreover, any combination of the above-described embodiments in all possible variations thereof is encompassed by the disclosure unless otherwise indicated herein or otherwise clearly contradicted by context.

What is claims is:

1. A system providing a phosphorescent liquid writing surface, the system comprising:
a pad comprising at least one substrate wherein a first coating is applied on at least one of the at least one substrates;
a second coating applied to the first coating; and
a pen comprising a cylindrical tube with a tip on one end and an opening on the other end defining a refillable reservoir wherein the reservoir may be filled with a liquid and a cap is removably attached to the opening;
wherein one of the coatings is a phosphorescent coating and one of the coatings alternates between transparent and opaque depending on the presence of a liquid.

2. The phosphorescence and liquid toy according to claim 1, wherein the second coating is phosphorescent.

3. The phosphorescence and liquid toy according to claim 1, wherein the first coating is liquid reactive material which includes silica and resin and is transparent when wet.

4. The phosphorescence and liquid toy according to claim 1, wherein the pen has a light removably attached to it.

5. The phosphorescence and liquid toy according to claim 2, wherein the liquid is water, tonic or luminous ink.

6. The phosphorescence and liquid toy according to claim 4, wherein the light is ultraviolet light or black light.

7. A method of manufacturing a phosphorescence liquid writing surface, the method comprising,
attaching a first substrate onto a second substrate with an attachment piece;
applying a first coating onto the first substrate;
allowing the first coating to cure;
applying a second coating onto the first coating
allowing the second coating to cure; and
providing a pen comprising a cylindrical tube with a tip on a tip end and an opening on an opening end defining a refillable reservoir wherein the reservoir may be filled with a liquid and a cap that is removably attached to the opening; and
tightening a light source onto one end of the pen.

8. A method of manufacturing according to claim 9, wherein the first substrate is woven material polyester.
